(19) United States
(12) Patent Application Publication
(10) Pub. No.: US 2006/0123680 A1
(43) Pub. Date: Jun. 15, 2006

(54) Display device for household devices

(75) Inventors: Reinhard Hering, Holzheim (DE); Michael Rosenbauer, Reimlingen (DE)

Correspondence Address: JOHN T. WINBURN, 100 BOSCH BOULEVARD, NEW BERN, NC, 28562, US

(73) Assignee: BSH Bosch und Siemens Hausgerate GmbH, Munich (DE)

(21) Appl. No.: 10/539,944

(22) PCT Filed: Dec. 3, 2003
(86) PCT No.: PCT/EP03/13652

§ 371 Date: Jan. 10, 2006

(30) Foreign Application Priority Data
Dec. 20, 2002 (DE) 102 60 161.5

(51) Int. Cl. G09F 13/06

(52) U.S. Cl. 40/580

(57) ABSTRACT

A display device for household devices includes a housing for receiving a plurality of light-emitting elements. The housing is at least partially covered by a film-type, partially translucent means having a plurality of specific regions. The light-emitting elements are arranged in the housing such that, during light emission, each light-emitting element only radiates through one of the specific regions of the translucent means. A pushbutton is associated with each of the specified regions for activating a corresponding one of the light-emitting elements.

The invention relates to a display device for household devices for displaying information on the running of the programme in said household devices, especially in dishwashers and washing machines.

In household appliances of the aforesaid type, the status of the respective programme, for example, of a rinsing or washing program is imparted pictorially to the user using programme controllers, LCD display panels or also by means of LED display panels. In the development of new types of machines, in addition to the technical improvement of individual assemblies, particular attention is also paid to the aesthetic appearance and the economical method of manufacturing the technical improvements. In this connection, attempts are especially being made to provide the aesthetic make-up of household appliances of a certain brand and/or price category with a certain appearance so that a certain recognition effect of the brand and the quality product is established in the user. In addition to this requirement, it is equally the task of the household appliance manufacturer, given the existing wide range of models, to use as many identical assemblies as possible in the respective different household appliance models since the economical manufacture of household appliances crucially depends on the corresponding batch sizes, i.e., the larger a batch size of an individual assembly, the more economically this assembly can be manufactured.

It is thus the object of the present invention to provide a display device for household appliances which, on the one hand, enables a high possibility of variation of the aesthetic make-up to be achieved in a plurality of different household appliance models, and on the other hand allows this possibility of variation to be achieved with the fewest possible changes of tools and material.

This technical object is solved by the display device according to the invention for household appliances having the features of claim 1.

Further features of the invention and advantageous embodiments of the invention are characterised in the dependent claims.

In the display device for household devices according to the invention, said display device consists of a housing for receiving a plurality of light-emitting elements and said housing is covered at least partially by a film-type, partially translucent means wherein the light-emitting elements are arranged in the housing such that during light emission each light-emitting element only radiates through a specific region of the translucent means and a pushbutton which is associated with each of said specified regions can be used to activate the corresponding light-emitting elements.

By allocating a pushbutton to a corresponding symbol, i.e. translucent region, the user is intuitively notified that on activation, i.e., mechanical actuation of the pushbutton, a symbol panel allocated directly above, for example, is activated and thus a selection of a rinsing or washing programme has been made.

According to a preferred embodiment of the invention, the housing consists of a thermoplastic material and has box-like recesses in which the light-emitting elements are arranged.

According to an advantageous embodiment of the invention, the light-emitting elements are arranged in the box-like recess such that the region covering the box-like recess is completely illuminated.

Advantageously, the film-type, partially translucent means are embodied as one piece and can be connected to the housing by means of form-locking connections and more suitably consist of a plastic wherein the translucent regions are accentuated with colour. The translucent regions accentuated with colour form the respective programme running information so that on activating the light-emitting elements, the observer sees a specific status symbol light up.

With the invention a different aesthetic make-up can be achieved in different household appliance models whilst retaining the inventive concept, wherein among others, the following possibilities of variation can be used:
graphical configuration of the symbols on the film-like means,
colour configuration of the translucent regions on the film-like medium,
arrangement of the respective symbols on the film-like means,
number of symbols on the film-like means,
shape of film-like means,
number and shape of the respective allocated pushbuttons,
arrangement of the pushbuttons above or below the film-like means.

With any combination of the afore-mentioned possibilities for variation, it is possible for the manufacturer of household appliances to undertake respectively different model identifications without needing to change the basic concept according to the invention. According to the invention, both the housing, the light-emitting elements, for example, LEDs and their colour and the technical substructure for the pushbuttons remain identical in all the devices according to the invention; only the film-like, partially translucent means and the pushbutton shape is changed according to the requirements of the individual models.

The display device for household appliances according to the invention for displaying programme running information in household appliances has the advantage that the vast majority of the parts of the device according to the invention to be manufactured can be mass produced and merely the film-like partially translucent means and the pushbuttons must be manufactured individually for the respective model.

The present invention provides a display device for household appliances which, on the one hand, enables a high possibility of variation of the aesthetic make-up to be achieved in a plurality of different household appliance models, and on the other hand allows this possibility of variation to be achieved with the fewest possible changes of tools and material.

The invention is explained subsequently with reference to an exemplary embodiment shown in the drawings.

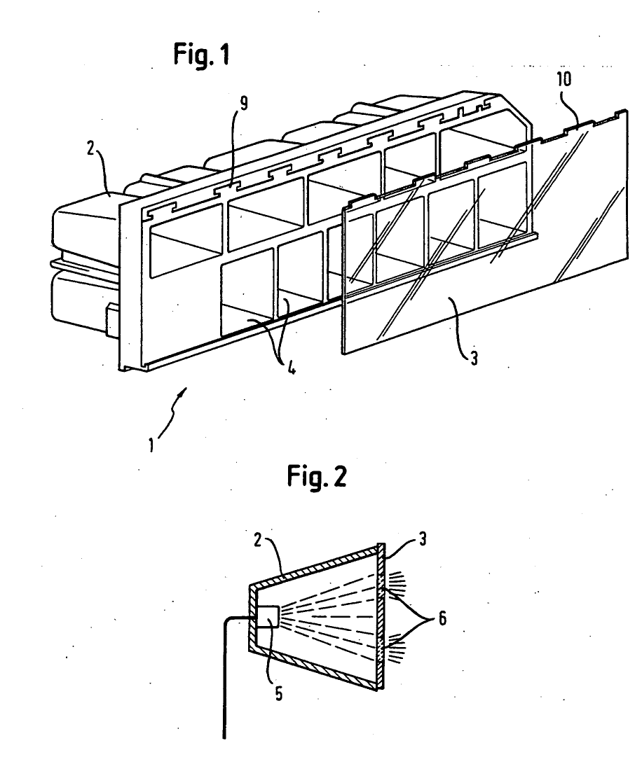

FIG. 1 is a perspective view of the device according to the invention,

FIG. 2 is a sectional view through a recess of the device according to the invention,

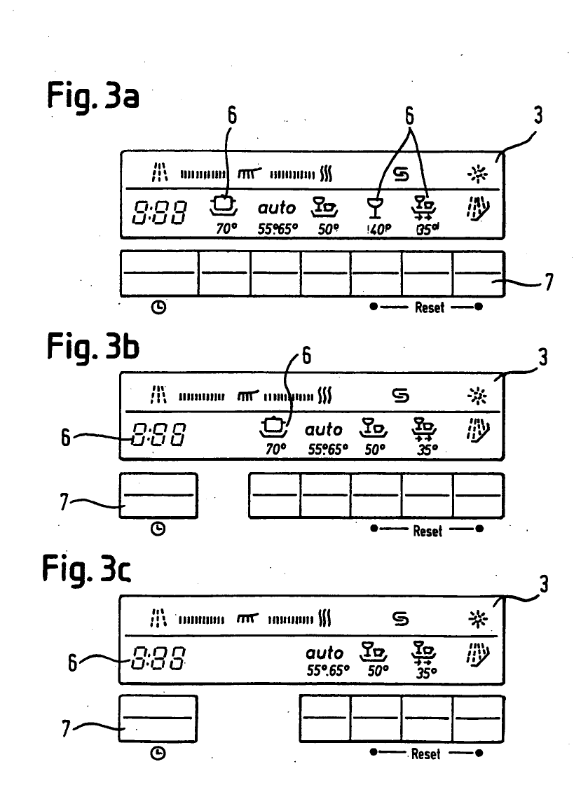

FIGS. 3a to 3c show different variants of the film-like translucent film,

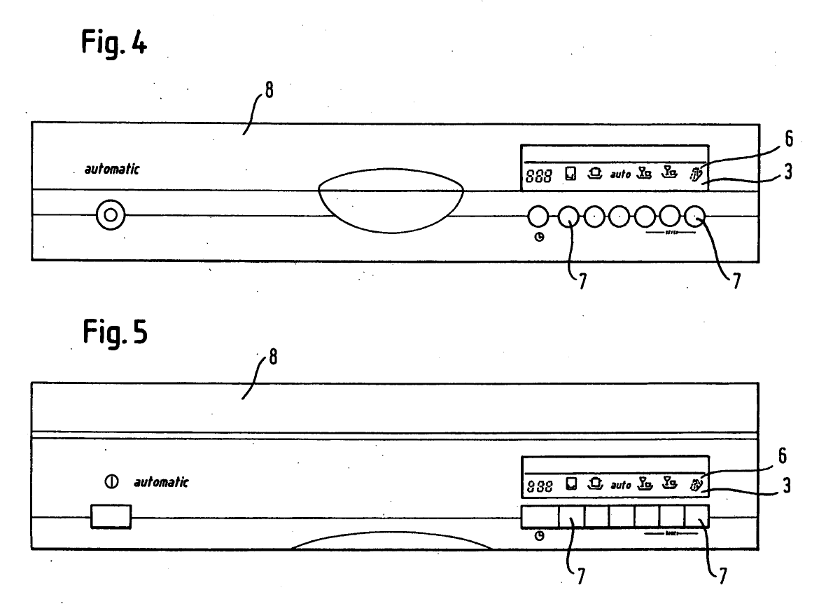

FIG. 4 shows an embodiment of a fascia of a dish washer with the device according to the invention and

FIG. 5 shows a fascia of another model variant of a dishwasher with a device according to the invention.

FIG. 1 shows a perspective view of the device 1 according to the invention with a housing 2 and box-like recesses 4 arranged therein, wherein the different box-like recesses 4 approximately correspond to the size of the respective symbols. For permanent connection of the film-like translucent means 3 to the housing 2, the housing 2 has corresponding locating means 9 and the film-like translucent means 3 have elevations 10 which form a positive contact when suitably joined which makes it at least very difficult to dismount the film-like translucent means 3 from the housing 2. A box-like recess 4 is shown in sectional view in FIG. 2. Located at the bottom of the box-like recess 4 is a light-emitting element 5 which for example, is a light-emitting diode which is connected to the programme control system by means of an electrical conductor.

The box-like recess 4 is covered by the film-like translucent means 3, wherein the film-like translucent means 3 has regions 6 which are permeable to light.

FIGS. 3a to 3c show different variants of the arrangement of symbols on the film-like translucent means 3 and a corresponding allocation of pushbuttons 7, wherein the allocation of the pushbuttons 7 is merely shown below the film-like translucent means 3. In an embodiment not shown pushbuttons are likewise arranged above the film-like translucent means 3 so that a greater variation of shape is provided.

In the embodiments according to FIGS. 3b and 3c, the pushbuttons 7 are not provided in any continuous series but with interruptions according to the diagram. Since the fascia of the household appliance has corresponding breaks at the points where a pushbutton 7 should project, the regions to which no pushbutton is allocated are screened.

It is unimportant for the technical realisation whether an operable switch which however has no function is possibly located behind the screen. The device according to the invention thus achieves the advantage that a plurality of model variants with an identical housing 2 can be provided with corresponding box-like recesses 4 and a row of pushbuttons 7 so that a large number of these basic components can be manufactured economically. FIGS. 4 and 5 show different pushbutton shapes 7 attached to different fascias 8.

The present invention provides a display device for household appliances which, on the one hand, enables a high possibility of variation of the aesthetic make-up to be achieved in a plurality of different household appliance models, and on the other hand allows this possibility of variation to be achieved with the fewest possible changes of tools and material.

1-5. (canceled)

6. A display device for household devices, comprising:
a housing for receiving a plurality of light-emitting elements, the housing being at least partially covered by a film-type, partially translucent means having a plurality of specific regions and the light-emitting elements being arranged in the housing such that, during light emission, each light-emitting element only radiates through one of the specific regions of the translucent means; and
a pushbutton associated with each of the specified regions for activating a corresponding one of the light-emitting elements.

7. The display device according to claim 6, wherein the housing is comprised of a thermoplastic material and has box-like recesses in which the light-emitting elements are arranged.

8. The display device according to claim 7, wherein the light-emitting elements are arranged in the box-like recess such that the region covering the box-like recess is completely illuminated.

9. The display device according to claim 6, wherein the film-type, partially translucent means is embodied as one piece and can be connected to the housing by means of form-locking connections.

10. The display device according to claim 9, wherein the film-like, partially translucent means is comprised of plastic and the specific regions of the translucent means are accentuated with color.

11. A display device for a household device, comprising:
a housing for receiving a plurality of light-emitting elements, the housing being at least partially covered by a partially translucent means having a plurality of specific regions and the light-emitting elements being arranged in the housing such that, during light emission, each light-emitting element only radiates through one of the specific regions of the translucent means; and
actuation means associated with the specified regions for activating selected ones of the light-emitting elements.
